(19) United States
(12) Patent Application Publication
(10) Pub. No.: US 2019/0024895 A1
(43) Pub. Date: Jan. 24, 2019

(54) COMBUSTOR DILUTION STRUCTURE FOR GAS TURBINE ENGINE

(71) Applicant: General Electric Company, Schenectady, NY (US)

(72) Inventors: Richard Wade Stickles, Loveland, OH (US); Clayton Stuart Cooper, Loveland, OH (US); Perumallu Vukanti, Bangalore (IN); Mayank Krisna Amble, Bangalore (IN)

(21) Appl. No.: 15/652,378

(22) Filed: Jul. 18, 2017

(51) Int. Cl. F23R 3/06; F23R 3/00

(52) U.S. Cl. CPC F23R 3/06; F02C 3/04; F23R 3/002

(57) ABSTRACT

The present disclosure is directed to a combustor assembly for a gas turbine engine. The combustor assembly includes an inner liner and an outer liner together defining a combustion chamber therebetween and a pressure plenum surrounding the inner liner and the outer liner. One or more of the inner liner and the outer liner defines one or more openings. The one or more liners includes a walled chute disposed at least partially within the opening. A structural member extends from the one or more liners to the walled chute.

### FIELD

The present subject matter relates generally to gas turbine engine combustion assemblies for gas turbine engines.

### BACKGROUND

Combustion assemblies for gas turbine engines generally include orifices in the combustion liners to dilute the combustion gases within the combustion chamber with air from the diffuser cavity. The air may be employed to mix with an over rich combustion gas mixture to complete the combustion process; to stabilize combustion flames within the recirculation zone of the combustion chamber; to minimize oxides of nitrogen emissions; or to decrease combustion gas temperature before egressing to the turbine section.

Although dilution orifices provide known benefits, there is a need for structures that may provide and improve upon these benefits via egressing the air into the combustion chamber in increasingly detailed or specific modes.

### BRIEF DESCRIPTION

Aspects and advantages of the invention will be set forth in part in the following description, or may be obvious from the description, or may be learned through practice of the invention.

The present disclosure is directed to a combustor assembly for a gas turbine engine. The combustor assembly includes an inner liner and an outer liner together defining a combustion chamber therebetween and a pressure plenum surrounding the inner liner and the outer liner. One or more of the inner liner and the outer liner defines one or more openings. The one or more liners includes a walled chute disposed at least partially within the opening. A structural member extends from the one or more liners to the walled chute.

In various embodiments, the walled chute extends at least partially into the combustion chamber. In one embodiment, the walled chute extends at an acute angle along the longitudinal direction into the combustion chamber. In another embodiment, the walled chute extends at least partially along the circumferential direction into the combustion chamber.

In still various embodiments, the opening defines a circular, ovular, racetrack, or teardrop cross section. In one embodiment, the structural member disposes the walled chute approximately equidistant within the opening from the liner. In another embodiment, the structural member disposes the walled chute forward or aft toward the liner.

In yet other embodiments, the walled chute extends into the pressure plenum. In one embodiment, the walled chute defines a walled dome in the pressure plenum, wherein the walled chute further defines a chute inlet through which a flow of air egresses from the pressure plenum through the walled chute into the combustion chamber. In another embodiment, the chute inlet is defined at an upstream end of the walled chute.

In various embodiments, the walled chute defines a first flow passage therethrough from the pressure plenum to the combustion chamber. The liner and the walled chute together define a second flow passage therebetween through the opening from the pressure plenum to the combustion chamber. In one embodiment, the first flow passage provides a flow of air from the pressure plenum to the combustion chamber at a higher velocity than the second flow passage. In other embodiments, the walled chute defines a decreasing cross-sectional area of the first flow passage from the pressure plenum to the combustion chamber. In another embodiment, the walled chute defines a nozzle providing an accelerating flow of air through the first flow passage from the pressure plenum to the combustion chamber.

In one embodiment, the walled chute defines a chute inlet adjacent to the pressure plenum, a chute outlet adjacent to the combustion chamber, and a first flow passage therebetween within the walled chute.

In still various embodiments, the walled chute defines a walled closure, and wherein a second flow passage is defined between the walled chute and the liner from the pressure plenum to the combustion chamber. In one embodiment, the walled chute extends into the pressure plenum at an acute angle at least partially along the longitudinal direction. In another embodiment, the walled chute provides a flow of air through an upstream end of the second flow passage from the pressure plenum to the combustion chamber at a higher velocity than a downstream end of the second flow passage.

Another aspect of the present disclosure is directed to a gas turbine engine including a combustor assembly comprising an inner liner and an outer liner together defining a combustion chamber therewithin and a pressure plenum surrounding the inner liner and the outer liner. One or more of the inner liner and the outer liner defines one or more openings. The one or more liners includes a walled chute disposed within the opening. A structural member extends from the one or more liners to the walled chute.

In one embodiment of the gas turbine engine, the walled chute defines a walled closure, and a second flow passage is defined between the walled chute and the liner from the pressure plenum to the combustion chamber.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic cross sectional view of an exemplary gas turbine engine incorporating an exemplary embodiment of a combustor assembly;

FIG. 2 is an axial cross sectional view of an exemplary embodiment of a combustor assembly of the exemplary engine shown in FIG. 1;

FIG. 3 is a detailed view of a portion of an exemplary embodiment of a combustor assembly; and

FIG. 4 is a top view of an exemplary embodiment of a portion of the combustor assembly liners;

FIG. 5 is a top view of another exemplary embodiment of a portion of the combustor assembly liners;

FIG. 6 is a top view of yet another exemplary embodiment of a portion of the combustor assembly liners;

FIG. 7 is a top view of still another exemplary embodiment of a portion of the combustor assembly liners;

FIG. 8 is a cross sectional side view of an exemplary embodiment of a portion of the combustor assembly liners;

FIG. 9 is a cross sectional side view of another exemplary embodiment of a portion of the combustor assembly liners;

FIG. 10 is a cross sectional side view of yet another exemplary embodiment of a portion of the combustor assembly liners;

FIG. 11 is a cross sectional side view of still another exemplary embodiment of a portion of the combustor assembly liners;

FIG. 12 is a top view of still yet another exemplary embodiment of a portion of the combustion assembly liners;

FIG. 13 is a cross sectional side view of still yet another exemplary embodiment of a portion of the combustor assembly liners; and

FIG. 14 is a cross sectional side view of another exemplary embodiment of a portion of the combustor assembly liners.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “upstream” and “downstream” refer to the relative direction with respect to fluid flow in a fluid pathway. For example, “upstream” refers to the direction from which the fluid flows, and “downstream” refers to the direction to which the fluid flows.

Embodiments of combustor assembly dilution structures are generally provided that may improve emissions and combustion gas quenching via egressing the air into the combustion chamber in increasingly detailed or specific modes. The various embodiments of combustor assemblies generally define a walled chute configured to egress air from the diffuser cavity to the combustion chamber in multiple or tailored modes.

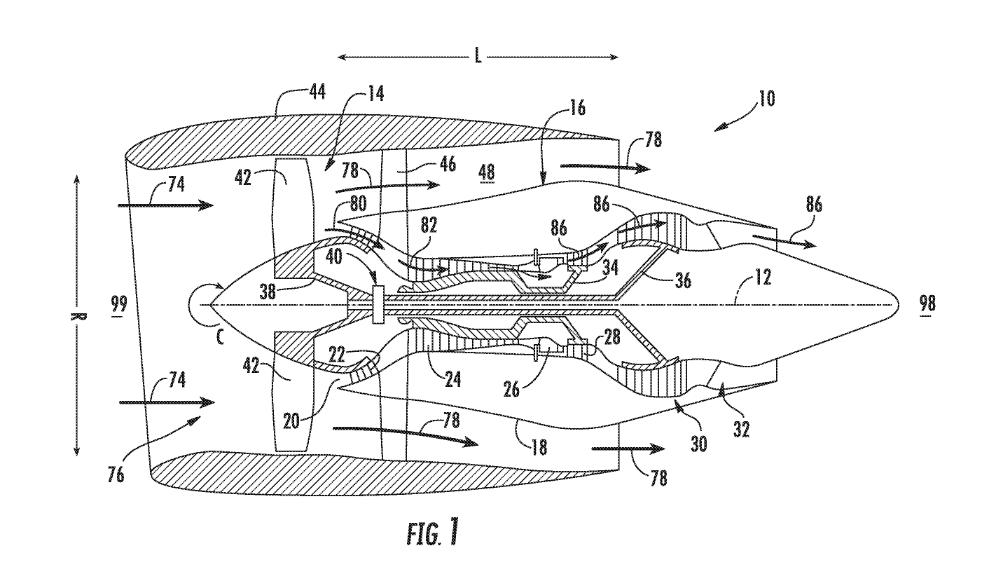

Referring now to the drawings, FIG. 1 is a schematic partially cross-sectioned side view of an exemplary high bypass turbofan engine 10 herein referred to as “engine 10” as may incorporate various embodiments of the present disclosure. Although further described below with reference to a turbofan engine, the present disclosure is also applicable to turbomachinery in general, including turbojet, turboprop, and turboshaft gas turbine engines, including marine and industrial turbine engines and auxiliary power units. As shown in FIG. 1, the engine 10 has a longitudinal or axial centerline axis 12 that extends there through for reference purposes. The engine 10 defines a longitudinal direction L and an upstream end 99 and a downstream end 98 along the longitudinal direction L. The upstream end 99 generally corresponds to an end of the engine 10 along the longitudinal direction L from which air enters the engine 10 and the downstream end 98 generally corresponds to an end at which air exits the engine 10, generally opposite of the upstream end 99 along the longitudinal direction L. In general, the engine 10 may include a fan assembly 14 and a core engine 16 disposed downstream from the fan assembly 14.

The core engine 16 may generally include a substantially tubular outer casing 18 that defines an annular inlet 20. The outer casing 18 encases or at least partially forms, in serial flow relationship, a compressor section having a booster or low pressure (LP) compressor 22, a high pressure (HP) compressor 24, a combustion section 26, a turbine section including a high pressure (HP) turbine 28, a low pressure (LP) turbine 30 and a jet exhaust nozzle section 32. A high pressure (HP) rotor shaft 34 drivingly connects the HP turbine 28 to the HP compressor 24. A low pressure (LP) rotor shaft 36 drivingly connects the LP turbine 30 to the LP compressor 22. The LP rotor shaft 36 may also be connected to a fan shaft 38 of the fan assembly 14. In particular embodiments, as shown in FIG. 1, the LP rotor shaft 36 may be connected to the fan shaft 38 by way of a reduction gear 40 such as in an indirect-drive or geared-drive configuration. In other embodiments, the engine 10 may further include an intermediate pressure compressor and turbine rotatable with an intermediate pressure shaft altogether defining a three-spool gas turbine engine.

As shown in FIG. 1, the fan assembly 14 includes a plurality of fan blades 42 that are coupled to and that extend radially outwardly from the fan shaft 38. An annular fan casing or nacelle 44 circumferentially surrounds the fan assembly 14 and/or at least a portion of the core engine 16. In one embodiment, the nacelle 44 may be supported relative to the core engine 16 by a plurality of circumferentially-spaced outlet guide vanes or struts 46. Moreover, at least a portion of the nacelle 44 may extend over an outer portion of the core engine 16 so as to define a bypass airflow passage 48 therebetween.

FIG. 2 is a cross sectional side view of an exemplary combustion section 26 of the core engine 16 as shown in FIG. 1. As shown in FIG. 2, the combustion section 26 may generally include an annular type combustor 50 having an annular inner liner 52, an annular outer liner 54 and a bulkhead 56 that extends radially between upstream ends 58, 60 of the inner liner 52 and the outer liner 54 respectively. In other embodiments of the combustion section 26, the combustion assembly 50 may be a can-annular type. The combustor 50 further includes a dome assembly 57 extended radially between the inner liner 52 and the outer liner 54 downstream of the bulkhead 56. As shown in FIG. 2, the inner liner 52 is radially spaced from the outer liner 54 with respect to engine centerline 12 (FIG. 1) and defines a generally annular combustion chamber 62 therebetween. In particular embodiments, the inner liner 52, the outer liner 54, and/or the dome assembly 57 may be at least partially or entirely formed from metal alloys or ceramic matrix composite (CMC) materials.

As shown in FIG. 2, the inner liner 52 and the outer liner 54 may be encased within an outer casing 64. An outer flow passage 66 of a diffuser cavity or pressure plenum 84 may be defined around the inner liner 52 and/or the outer liner 54. The inner liner 52 and the outer liner 54 may extend from the bulkhead 56 towards a turbine nozzle or inlet 68 to the HP turbine 28 (FIG. 1), thus at least partially defining a hot gas path between the combustor assembly 50 and the HP turbine 28. A fuel nozzle 70 may extend at least partially through the bulkhead 56 to provide a fuel-air mixture 72 to the combustion chamber 62. In various embodiments, the bulkhead 56 includes a fuel-air mixing structure attached thereto (e.g., a swirler assembly).

Referring still to FIG. 2, the inner liner 52 and the outer liner 54 each define one or more openings 105 through the liners 52, 54. A walled chute 100 is disposed at least partially within the opening 105. One or more structural members 110 extends from the liner 52, 54 to the walled chute 100. In various embodiments, the structural members 110 dispose the walled chute 100 generally concentric or equidistant within the opening 105 from the liner 52, 54, such as generally provided in FIGS. 4-6. In other embodiments, such as generally provided in FIG. 7, the walled chute 100 is biased forward or aft along the longitudinal direction L, or along the circumferential direction C, such that the walled chute 100 is eccentric within the opening 105 (i.e., the walled chute 100 is unequally distant from all sides of the liner 52, 54).

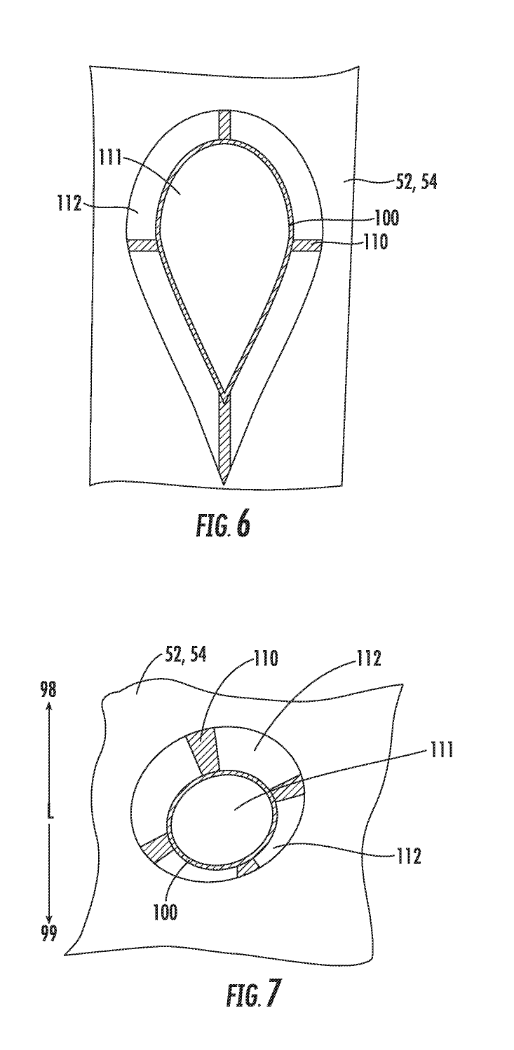

As shown in FIG. 2, and in additional embodiments generally provided in FIGS. 8-11, the walled chute 100 extends at least partially into the combustion chamber 62. The walled chute 100 generally defines a walled enclosure defining a first flow passage 111 therethrough from the pressure plenum 84 to the combustion chamber 62. In various embodiments, the walled chute 100 defines a chute inlet 113 adjacent to the pressure plenum 84 and a chute outlet 117 adjacent to the combustion chamber 62, and the first flow passage 111 therebetween. The walled chute 100 and the liner 52, 54 further defines a second flow passage 112 therebetween through the opening 105 from the pressure plenum 84 to the combustion chamber 62.

During operation of the engine 10, as shown in FIGS. 1 and 2 collectively, a volume of air as indicated schematically by arrows 74 enters the engine 10 through an associated inlet 76 of the nacelle 44 and/or fan assembly 14. As the air 74 passes across the fan blades 42 a portion of the air as indicated schematically by arrows 78 is directed or routed into the bypass airflow passage 48 while another portion of the air as indicated schematically by arrow 80 is directed or routed into the LP compressor 22. Air 80 is progressively compressed as it flows through the LP and HP compressors 22, 24 towards the combustion section 26. As shown in FIG. 2, the now compressed air as indicated schematically by arrows 82 flows into a diffuser cavity or pressure plenum 84 of the combustion section 26. The pressure plenum 84 generally surrounds the inner liner 52 and the outer liner 54, and generally upstream of the combustion chamber 62.

The compressed air 82 pressurizes the pressure plenum 84. A first portion of the of the compressed air 82, as indicated schematically by arrows 82(a) flows from the pressure plenum 84 into the combustion chamber 62 where it is mixed with the fuel 72 and burned, thus generating combustion gases, as indicated schematically by arrows 86, within the combustor 50. Typically, the LP and HP compressors 22, 24 provide more compressed air to the pressure plenum 84 than is needed for combustion. Therefore, a second portion of the compressed air 82 as indicated schematically by arrows 82(b) may be used for various purposes other than combustion. For example, as shown in FIG. 2, compressed air 82(b) may be routed into the outer flow passage 66 to provide cooling to the inner and outer liners 52, 54.

Additionally, at least a portion of compressed air 82(b) flows out of the pressure plenum 84 into the combustion chamber 62 via the first flow passage 111 and/or second flow passage 112 defined by the walled chute 100 and liner 52, 54. Referring to FIGS. 8-11, a portion of the compressed air 82(b), shown schematically as arrows 83, egresses from the pressure plenum 84 through the first flow passage 111 into the combustion chamber 62. Furthermore, a portion of compressed air 82(b), shown schematically as arrows 85, egresses from the pressure plenum 84 through the second flow passage 112 through the opening 105 defined between the walled chute 100 and the liner 52, 54.

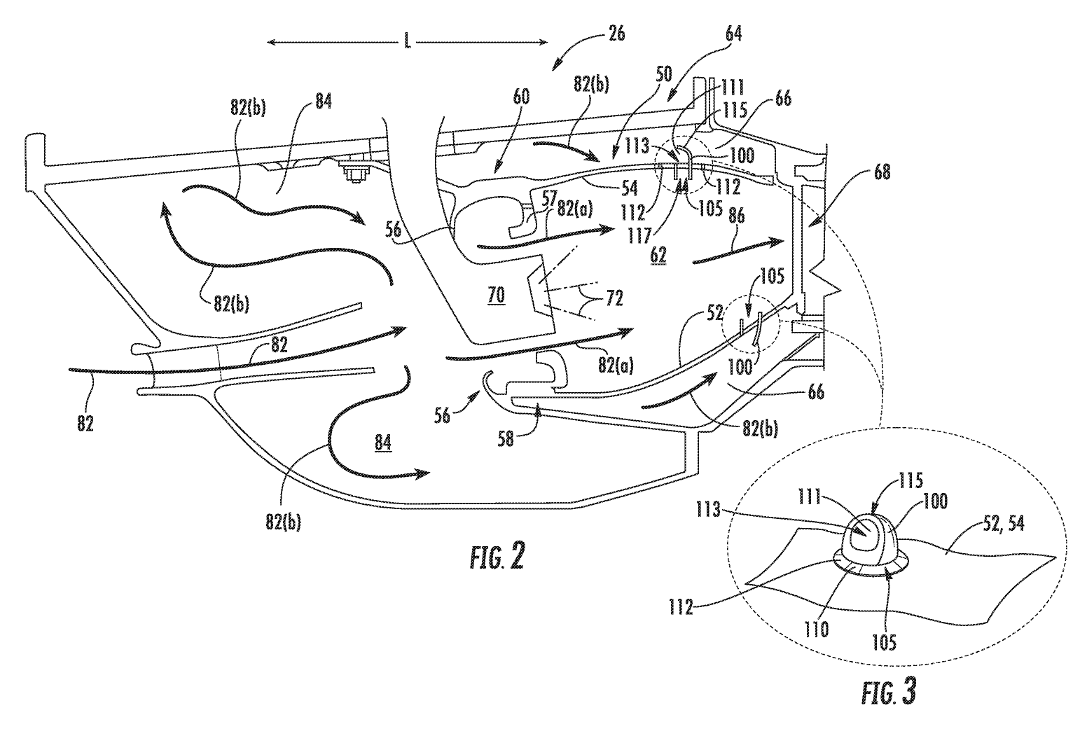

In various embodiments, such as shown in FIGS. 3-11, the walled chute 100 further extends at least partially into the pressure plenum 84. The walled chute 100 extends at least partially upstream. The walled chute 100 may further define a walled dome 115 within the pressure plenum 84. The chute inlet 113 is defined within the walled chute 100, or more specifically, the walled dome 115. For example, the chute inlet 113 is defined at an upstream end of the walled chute 100, such as to provide a flow of air 82(b) from the pressure plenum 84 through the first flow passage 111 (shown as arrows 83) into the combustion chamber 62.

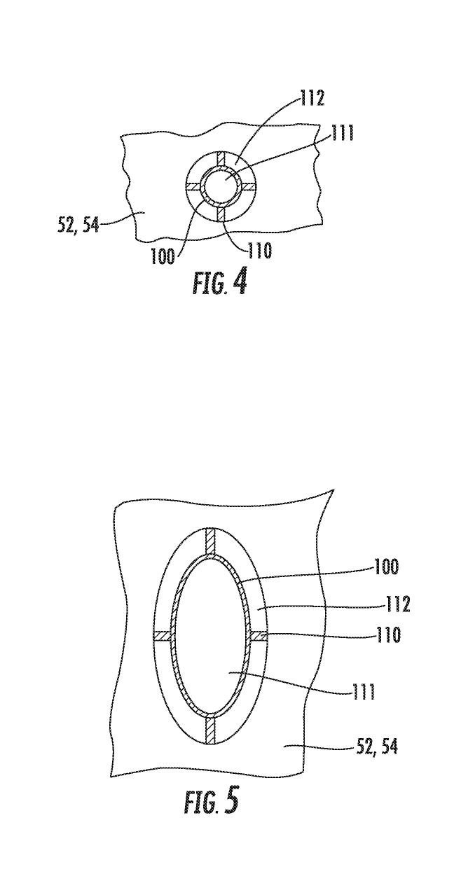

Referring now to FIGS. 4-7, top-down views of various embodiments are generally provided depicting various cross sections of the walled chute 100 and liner 52, 54 together defining the opening 105 and second flow passage 112. The embodiments provided in FIGS. 4-7 generally include substantially the same features as previously described herein. In FIG. 4, the opening 105 and the walled chute 100 each generally define a circular cross section. The walled chute 100 is defined generally concentric within the opening 105. In FIG. 5, the opening 105 defines a generally ovular or racetrack cross section, in which the walled chute 100 is defined generally equidistant within the opening 105 from the liner 52, 54. In various embodiments, the opening 105 and the second flow passage 112 may generally define an oblong cross section. In FIG. 6, the opening 105 defines a generally teardrop or airfoil cross section through the liner 52, 54. The walled chute 100 is generally equidistant from the liner 52, 54 within the opening 105.

In FIG. 7, the walled chute 100 is generally depicted as eccentric within the opening 105. In various embodiments, the walled chute 100 may be biased or disposed forward or aft along the longitudinal direction L (see FIG. 1), or biased along the circumferential direction C (see FIG. 1). For example, the flow of air 85 through the second flow passage 112 from the pressure plenum 84 to the combustion chamber 62 may generally flow at a higher velocity at the upstream end 99 relative to a downstream end 98 along the longitudinal direction L of the second flow passage 112. Although generally depicted as generally circular cross sections such as generally provided in FIG. 4, the eccentric arrangement generally provided in FIG. 7 may further be applied to the cross sections generally provided in FIGS. 5-6. Still further, in various embodiments, the opening 105, the walled chute 100, or both may define other cross sections, such as, but not limited to, polygonal, asymmetric, oblong, multi-point stars, etc.

Referring now to FIGS. 8-11, cross sectional side views of various embodiments are generally provided depicting various cross sections of the walled chute 100. The embodiments provided in FIGS. 8-11 generally include substantially the same features as previously described herein. In each embodiment, the walled chute 100 extends at least partially into the combustion chamber 62 and the pressure plenum 84. In FIG. 9, the walled chute 100 extends at least partially along the longitudinal direction L toward the downstream end 98. The flow of air 83 through the first flow passage 111 is biased or disposed toward the downstream direction when egressing from the pressure plenum 84 through the combustion chamber 62.

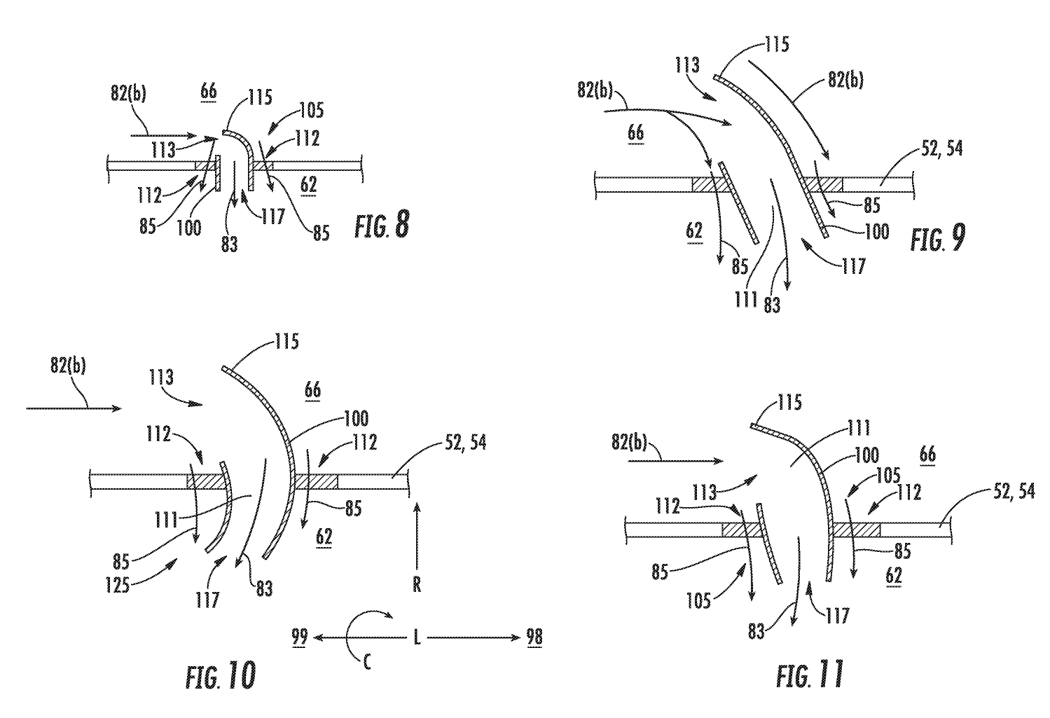

In FIG. 10, the walled chute 100 extends at least partially along the longitudinal direction L toward the upstream end 99. The flow of air 83 through the first flow passage 111 is biased or disposed toward the upstream direction when egressing from the pressure plenum 84 through the combustion chamber 62.

In FIG. 11, the walled chute 100 defines a generally decreasing cross sectional area through the first flow passage 111 from the pressure plenum 84 to the combustion chamber 62. The decreasing cross sectional area of the walled chute 100 may define a nozzle providing an accelerating flow of air 83 through the first flow passage 111.

Referring to FIGS. 8-11, each embodiment generally configures the walled chute 100 and the first flow passage 111 therethrough to provide the air 83 from the pressure plenum 84 to the combustion chamber 62 at a relatively higher velocity that the second flow passage 112 through which the portion of air 85 (from air 82(b)) egresses from the pressure plenum 84 to the combustion chamber 62.

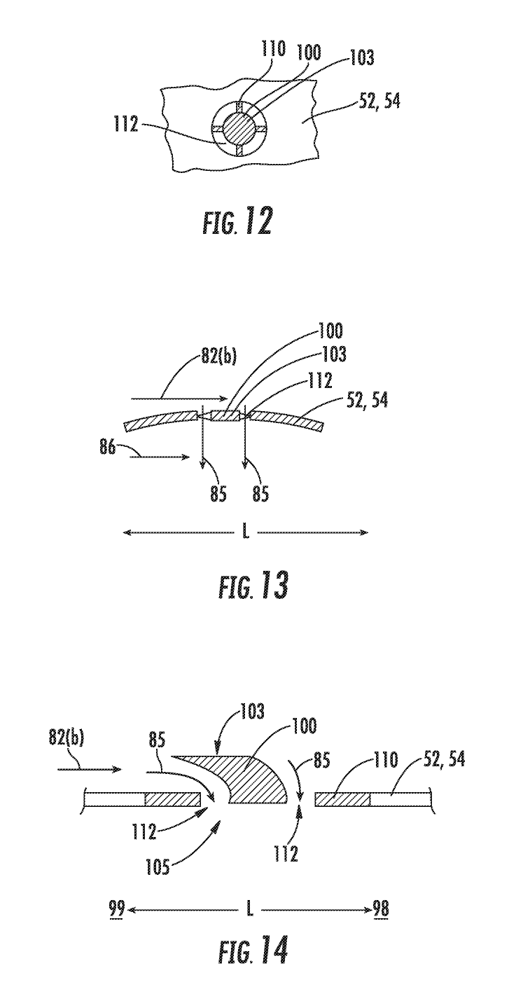

Referring now to FIG. 12, a top view of the walled chute 100 is generally provided in which the walled chute 100 defines a walled closure 103. Referring now to the side views of exemplary embodiments generally provided in FIGS. 13-14 in conjunction with the top view generally provided in FIG. 12, the walled chute 100 and the liner 52, 54 defines the second flow passage 112 therebetween (e.g., around the walled chute 100) from the pressure plenum 84 to the combustion chamber 62. The walled closure 103 disables a flow of air through the first flow passage 111.

Referring now to FIG. 14, in the embodiment generally provided, the walled chute 100 extends at least partially into the pressure plenum 84 at an acute angle relative to the longitudinal direction L. The walled chute 100 may enable a higher velocity of air 85 through the second flow passage 112 toward the upstream end 99 versus the downstream end 98. However, in other embodiments, the walled chute 100 can be configured to provide a higher velocity of air 85 through the second flow passage 112 at the downstream end 98 versus the upstream end 99.

Referring back to FIGS. 1 and 2 collectively, the combustion gases 86 generated in the combustion chamber 62 flow from the combustor assembly 50 into the HP turbine 28, thus causing the HP rotor shaft 34 to rotate, thereby supporting operation of the HP compressor 24. As shown in FIG. 1, the combustion gases 86 are then routed through the LP turbine 30, thus causing the LP rotor shaft 36 to rotate, thereby supporting operation of the LP compressor 22 and/or rotation of the fan shaft 38. The combustion gases 86 are then exhausted through the jet exhaust nozzle section 32 of the core engine 16 to provide propulsive thrust.

Various embodiments of the combustor assembly 50 provided herein, including the exemplary embodiments of the walled chute 100 defined in the inner liner 52, the outer liner 54, or both, may increase penetration of the jet of air 83 through the first flow passage 111 into the combustion chamber 62 by capturing total pressure feed air 82(b) within the combustor assembly 50. The surrounding second flow passage 112 defined between the walled chute 100 and the liner 52, 54 may generally define a lesser penetration of the jet of air 85 into the combustion chamber 62 by capturing static pressure feed of air 82(b). The difference in penetration (e.g., pressure, flow rate) between the air 83 through the first flow passage 111 and the air 85 through the second flow passage 112 may improve mixing with the combustion gases 86, thereby reducing formation of oxides of nitrogen. Furthermore, the air 85 flowing through the second flow passage 112 may further provide cooling to the walled chute 100. In various embodiments, the air 85 may more specifically provide cooling to at least a portion of the walled chute 100 extended into the combustion chamber 62 (e.g., a portion of the walled chute 100 proximate to the combustion gases 86).

Various embodiments of the combustor assembly 50 may define a rich burn combustor in which the walled chute 100 may define dilution jets providing additional mixing air (e.g., air 83, 85) with an mixture of combustion gases (e.g., combustion gases 86) to complete the combustion process. The walled chute 100 may further define dilution jets that further enable or augment a combustion recirculation zone within the combustion chamber 62 to stabilize flame therein. Still further, the walled chute 100 may define dilution jets that may relatively rapidly quench the combustion gases 86 to minimize production of nitrogen oxides. Furthermore, various embodiments of the combustor assembly 50 and walled chute 100 shown and described herein may enable customization of a distribution of combustion gas temperature to improve durability of components downstream of the combustor assembly 50 (e.g., the HP turbine 28).

All or part of the combustor assembly may be part of a single, unitary component and may be manufactured from any number of processes commonly known by one skilled in the art. These manufacturing processes include, but are not limited to, those referred to as “additive manufacturing” or “3D printing”. Additionally, any number of casting, machining, welding, brazing, or sintering processes, or any combination thereof may be utilized to construct the combustor 50, including, but not limited to, the bulkhead 56, the bulkhead support 61, the liners 52, 54, the walled chute 100, the structural members 110, or combinations thereof. Furthermore, the combustor assembly may constitute one or more individual components that are mechanically joined (e.g. by use of bolts, nuts, rivets, or screws, or welding or brazing processes, or combinations thereof) or are positioned in space to achieve a substantially similar geometric, aerodynamic, or thermodynamic results as if manufactured or assembled as one or more components. Non-limiting examples of suitable materials include high-strength steels, nickel and cobalt-based alloys, and/or metal or ceramic matrix composites, or combinations thereof.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A combustor assembly for a gas turbine engine, the combustor assembly defining a longitudinal direction, a radial direction, and a circumferential direction, the combustor assembly comprising:
an inner liner and an outer liner together defining a combustion chamber therebetween and a pressure plenum surrounding the inner liner and the outer liner, wherein one or more of the inner liner and the outer liner defines one or more openings, and wherein the one or more liners comprises a walled chute disposed at least partially within the opening, and wherein a structural member extends from the one or more liners to the walled chute.

2. The combustor assembly of claim 1, wherein the walled chute extends at least partially into the combustion chamber.

3. The combustor assembly of claim 2, wherein the walled chute extends at an acute angle along the longitudinal direction into the combustion chamber.

4. The combustor assembly of claim 2, wherein the walled chute extends at least partially along the circumferential direction into the combustion chamber.

5. The combustor assembly of claim 1, wherein the opening defines a circular, ovular, racetrack, or teardrop cross section.

6. The combustor assembly of claim 5, wherein the structural member disposes the walled chute approximately equidistant within the opening from the liner.

7. The combustor assembly of claim 5, wherein the structural member disposes the walled chute forward or aft toward the liner.

8. The combustor assembly of claim 1, wherein the walled chute extends into the pressure plenum.

9. The combustor assembly of claim 8, wherein the walled chute defines a walled dome in the pressure plenum, wherein the walled chute further defines a chute inlet through which a flow of air egresses from the pressure plenum through the walled chute into the combustion chamber.

10. The combustor assembly of claim 9, wherein the chute inlet is defined at an upstream end of the walled chute.

11. The combustor assembly of claim 1, wherein the walled chute defines a first flow passage therethrough from the pressure plenum to the combustion chamber, and wherein the liner and the walled chute together define a second flow passage therebetween through the opening from the pressure plenum to the combustion chamber.

12. The combustor assembly of claim 11, wherein the first flow passage provides a flow of air from the pressure plenum to the combustion chamber at a higher velocity than the second flow passage.

13. The combustor assembly of claim 11, wherein the walled chute defines a decreasing cross-sectional area of the first flow passage from the pressure plenum to the combustion chamber.

14. The combustor assembly of claim 13, wherein the walled chute defines a nozzle providing an accelerating flow of air through the first flow passage from the pressure plenum to the combustion chamber.

15. The combustor assembly of claim 1, wherein the walled chute defines a chute inlet adjacent to the pressure plenum, a chute outlet adjacent to the combustion chamber, and a first flow passage therebetween within the walled chute.

16. The combustor assembly of claim 1, wherein the walled chute defines a walled closure, and wherein a second flow passage is defined between the walled chute and the liner from the pressure plenum to the combustion chamber.

17. The combustor assembly of claim 16, wherein the walled chute extends into the pressure plenum at an acute angle at least partially along the longitudinal direction.

18. The combustor assembly of claim 17, wherein the walled chute provides a flow of air through an upstream end of the second flow passage from the pressure plenum to the combustion chamber at a higher velocity than a downstream end of the second flow passage.

19. A gas turbine engine defining a longitudinal direction, a radial direction, and a circumferential direction, and an upstream end and a downstream end, the gas turbine engine comprising:
a combustor assembly comprising an inner liner and an outer liner together defining a combustion chamber therewithin and a pressure plenum surrounding the inner liner and the outer liner, wherein one or more of the inner liner and the outer liner defines one or more openings, and wherein the one or more liners comprises a walled chute disposed within the opening, and wherein a structural member extends from the one or more liners to the walled chute.

20. The gas turbine engine of claim 19, wherein the walled chute defines a walled closure, and wherein a second flow passage is defined between the walled chute and the liner from the pressure plenum to the combustion chamber.
